(19) United States
(12) Patent Application Publication
(10) Pub. No.: US 2017/0303276 A1
(43) Pub. Date: Oct. 19, 2017

(54) TECHNIQUES FOR OFDMA RATE ADAPTATION

(71) Applicant: QUALCOMM Incorporated, San Diego, CA (US)

(72) Inventors: Chao CHENG, Santa Clara, CA (US); Ning ZHANG, Saratoga, CA (US); Youhan KIM, San Jose, CA (US); Chin-Hung CHEN, Milpitas, CA (US)

(21) Appl. No.: 15/487,026

(22) Filed: Apr. 13, 2017

Related U.S. Application Data
(60) Provisional application No. 62/323,357, filed on Apr. 15, 2016.

(51) Int. Cl. H04W 72/04; H04L 5/00; H04W 28/02; H04B 17/309; H04B 7/04

(52) U.S. Cl. CPC H04W 72/0446; H04W 28/0236; H04B 17/309; H04L 5/0007; H04B 7/0452

(57) ABSTRACT

The disclosure provides for rate adaptation based on channel power tracking in wireless communications. An Access Point (AP) may measure a full-band channel quality information (CQI) for a plurality of wireless stations associated with the AP and allocate a sub-band resource unit from the plurality of sub-band resource units to a wireless station based on the full-band CQI. Aspects of the disclosure also include techniques for adjusting a data rate associated with the wireless station based on a channel power of the sub-band resource unit.

### CROSS-REFERENCE TO RELATED APPLICATION(S)

This application claims benefit of U.S. Provisional Application Ser. No. 62/323,357, entitled “TECHNIQUES FOR OFDMA RATE ADAPTATION” and filed Apr. 15, 2016, which is expressly incorporated by reference herein in its entirety.

### FIELD OF THE DISCLOSURE

Aspects of this disclosure relate generally to telecommunications, and more particularly to techniques for Orthogonal Frequency-Division Multiple Access (OFDMA) rate adaptation based on channel power tracking in groups of multiple wireless local area network (WLAN) users.

### BACKGROUND

The deployment of WLANs in the home, the office, and various public facilities is commonplace today. Such networks typically employ a wireless access point (AP) that connects a number of wireless stations (STAs) in a specific locality (e.g., home, office, public facility, etc.) to another network, such as the Internet or the like. A set of STAs can communicate with each other through a common AP in what is referred to as a basic service set (BSS). Nearby BSSs may have overlapping coverage areas and such BSSs may be referred to as overlapping BSSs or OBSSs.

In some WLANs, wireless radio channels may typically be subjected to bit errors. Particularly, with rapid proliferation of IEEE 802.11 devices, denser WLAN deployments may negatively impact channel conditions between STAs and corresponding APs. Thus, wireless radio channels may not only be subjected to noise, interference, and other channel impediments, but these impediments may continuously change over time. In order to communicate reliably on the wireless radio channel, a transmitting device (e.g., STA or AP) generally protects its transmission data bits against wireless link impairments such as attenuation, fading, and noise via a combination of channel coding and modulation schemes, which together dictate the achieved bitrate.

Generally, higher bitrates correspond to higher nominal throughput but require higher signal-to-noise rations (SNR) for correct demodulation. However, in an SNR-limited environment, higher bitrates may suffer from frame errors, limiting the effective throughput. In such an environment, lower bitrates may provide higher effective throughput than higher rates. Thus, IEEE 802.11 radios utilize rate adaptation to dynamically adjust the transmission rates to maximize throughput depending on time-varying channel environments.

Conventional systems for rate adaptation are generally based on infererences gained from packet error rate (PER) of packets previously received at the receiving device. However, such systems rely on significant resource overhead in terms of large number of packets that need to be received and analyzed in order to identify the appropriate data rate. Even so, the inferred channel condition may be wildly inaccurate since packet delivery is a coarse measure.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques of the present disclosure provide an efficient solution, as compared to the conventionals systems, by performing OFDMA rate adaptation based on channel power tracking. Particularly, aspects of the present disclosure provide techniques for the AP to allocate sub-band resource units (RU) from a full-band that correspond with the peak channel power of each of the plurality of wireless stations based on the measurements of full-band channel quality information (CQI). In some aspects, a full-band may include a plurality of sub-band resource units. By allocating the identified peak channel power sub-band resource unit(s) to each of the plurality of wireless stations, aspects of the present disclosure allow each wireless station to transmit at a higher data rate than the conventional systems.

Further, aspects of the present disclosure provide improvements over conventional systems by tracking the channel power of the sub-band resource unit(s) during an uplink OFDMA transmission by the plurality of wireless stations and adjusting the data rate(s) associated with the wireless station(s) based on the channel power of the sub-band resource unit(s). By adjusting the data rate(s) based on the channel power of the sub-band resource unit(s), the AP does not need to continuously perform a full-band CQI for the plurality of STAs, and thus improves overall system efficiency. Finally, techniques of the present disclosure provide additional advantage of grouping the wireless stations for uplink communications based on consideration of the power imbalance tolerances of the AP when identifying ideal data rate(s) for each of the plurality of stations.

Accordingly, in an aspect, methods, apparatus, and computer-readable medium relate to rate adaptation in wireless communications. For example, a method includes measuring, at an AP, a full-band CQI for a plurality of wireless stations associated with the AP, wherein the full-band includes a plurality of sub-band resource units. The method further includes allocating a sub-band resource unit from the plurality of sub-band resource units to a wireless station of the plurality of wireless stations based on the full-band CQI. The method also includes adjusting a data rate associated with the wireless station based on a channel power of the sub-band resource unit. The method may further include communicating, from the AP, the data rate to the wireless station to allow the wireless station to utilize the data rate to communicate with the AP.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout, where dashed lines may indicate optional components or actions, and wherein:

FIG. 1 is a conceptual diagram illustrating an example of a wireless local area network (WLAN) deployment.

FIG. 2 is a schematic diagram of a communication network including aspects of a wireless station and an access point in a WLAN in accordance with various aspects of the present disclosure.

FIGS. 3A and 3B are diagrams illustrating sub-band resource allocations based on identification of the peak channel power for the wireless stations in a wireless network.

FIGS. 4A-4C are diagrams that illustrate communication between AP and one or more wireless stations with respect to rate adaptation based on channel power tracking in accordance with various aspects of the present disclosure.

FIG. 5 is a flow diagram illustrating an example method of OFDMA rate adaptation for a wireless station in a multi-user group in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

The present aspects generally relate to orthogonal frequency division multiple access (OFDMA) rate adaptation based on channel power tracking that provides for faster and more accurate data rate determination than the conventional systems. In some aspects, the rate adaptation techniques described herein may apply to IEEE 802.11-ax devices. Particularly, as discussed above, in order to communicate reliably on a wireless channel, a transmitting device (e.g., STA or AP) generally protects its transmission data bits against wireless channel impairments such as attenuation, fading, and noise via a combination of channel coding and modulation schemes, which together dictate the achieved bitrate. IEEE 802.11 radios utilize rate adaptation to dynamically adjust the transmission rates to maximize throughput depending on time-varying channel environments. Conventional systems for rate adaptation, in contrast, are generally based on infererences gained from packet error rate (PER) of packets previously received at the receiving device. However, such systems rely on significant overhead in terms of large number of packets that need to be received and analyzed in order to identify the appropriate data rate. Moreover, the inferred channel condition may be wildly inaccurate since packet delivery is a coarse measure.

Further, in multi-user multiple-input, multiple-output (MU-MIMO) technology, an AP can transmit to and receive data from multiple STAs at the same time. Although a multiple access technique such as OFDMA is used to permit the multiple STAs to transmit at the same time, power imbalances may prevent the AP from being able to correctly receive a signal from one or more STAs. A power imbalance at the AP may refer to a difference in the level of received signal strength from one STA in relation to one or more other STAs. In some aspects, the signal strength can be a measurement of signal power to interference and/or noise. A power imbalance may impair the ability of an AP to correctly receive a receive chain from multiple STAs. For example, in an aspect, the dynamic range of an analog-to-digital converter (ADC) may limit the ability of the AP to receive signals from both strong STAs (e.g., STAs closer to the AP) and a weak STAs (e.g., STAs that may be near the edge of AP's coverage area). Additionally, in some examples, the wireless system may experience inter carrier interference due to carrier frequency offset and phase noise distortion. Conventional systems fail to account for the power imbalance at the AP when determining data rates for transmission on wireless channels.

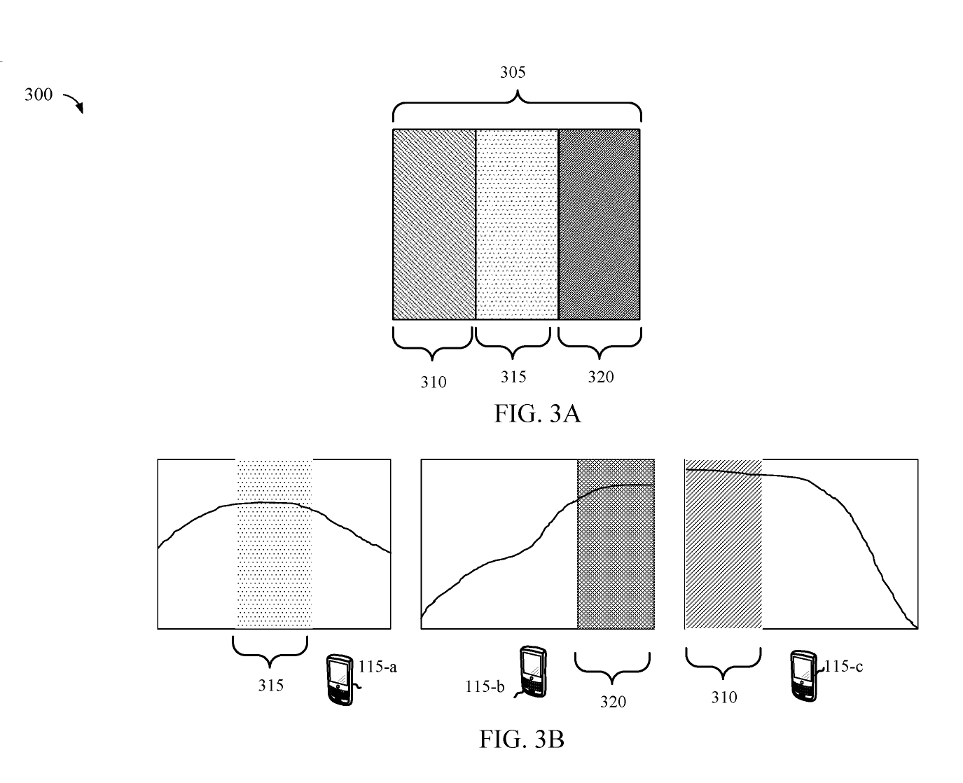

Accordingly, in some aspects, features of the present disclosure provide an efficient solution, as compared to the conventional systems, by performing OFDMA rate adaptation based on channel power tracking. Particularly, aspects of the present disclosure provide techniques for the AP to allocate sub-band resource unit(s) (RUs) to the plurality of STAs based on measurements of full-band CQI. In some aspects, allocating the sub-band resource unit(s) to the plurality of wireless stations may include identifying the sub-band resource unit(s) that correspond with a peak channel power (see e.g., FIG. 3) for the plurality of STAs based on the full-band CQI and allocating the identified sub-band resource unit(s) to the plurality of STAs. In further examples, the techniques of the present disclosure include monitoring (or “tracking” used interchangeably) the channel power of the sub-band resource unit(s) during an uplink OFDMA transmission by the plurality of STAs. Monitoring the channel power of the sub-band resource unit(s) may provide metrics for fine tuning rate adaptation for the AP. For example, if the metrics associated with the channel power indicate that the magnitude of channel fading is too large, the AP may perform full-band (FB) CQI update and reallocate sub-band resource units to account for the channel variations. Accordingly, the AP may dynamically adjust a data rate(s) associated with each of the associated STAs respectively based on a channel power of the sub-band resource units and communicate the modified data rate(s) to the STAs such that the STAs may utilize the adjusted data rate(s) to communicate with the AP.

Additionally or alternatively, in some examples, the CQI collected by the AP may include collecting a first partial band CQI from a first client (e.g., first STA) and a second partial band CQI from a second client (e.g., second STA). For example, a first STA may be allocated a first partial band (e.g., lower half of the full band), while a second STA may be allocated a second partial band (e.g., upper half of the full band). Accordingly, features of the present disclosure provide techniques to schedule the first STA and the second STA with downlink OFDMA and use each of the first STA and second STA corresponding OFDMA acknowledgment (ACKs) to obtain CQI for the first partial band and second partial band respectively.

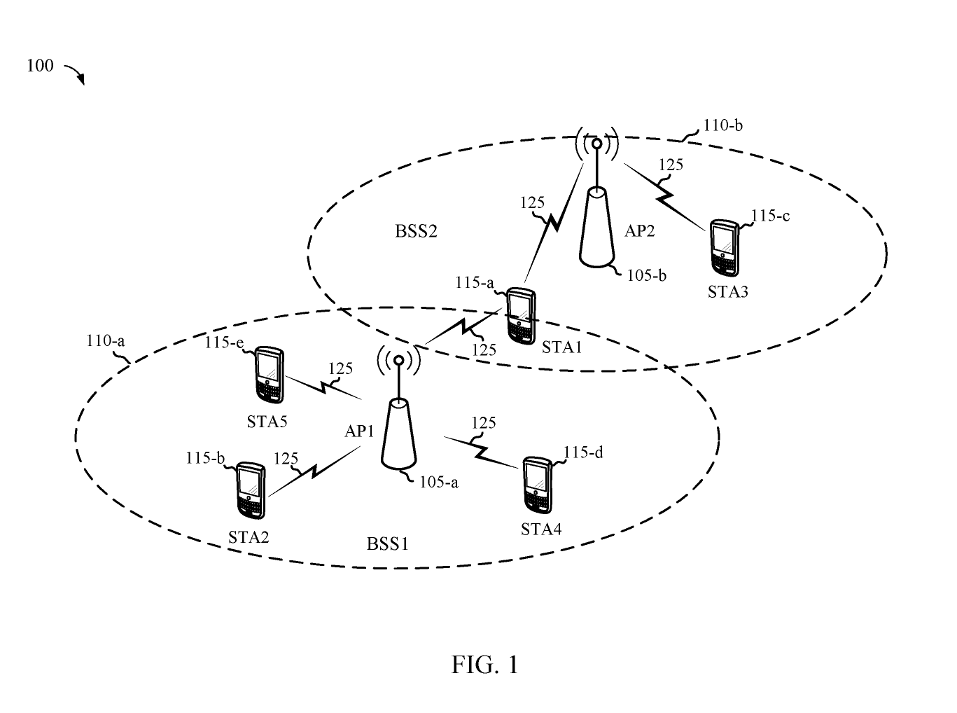

FIG. 1 is a wireless communication system 100 illustrating an example of a wireless local area network (WLAN) deployment in connection with various techniques described herein. The WLAN deployment may include one or more access points (APs) and one or more wireless stations (STAs) associated with a respective AP. In this example, there are only two APs deployed for illustrative purposes: AP1 105-a in basic service set 1 (BSS1) and AP2 105-b in BSS2. AP1 105-a is shown having at least two associated STAs (STA1 115-a, STA2 115-b, STA4 115-d, and STA5 115-e) and coverage area 110-a, while AP2 105-b is shown having at least two associated STAs (STA1 115-a and STA3 115-c) and coverage area 110-b. In the example of FIG. 1, the coverage area of AP1 105-a overlaps part of the coverage area of AP2 105-b such that STA1 115-a is within the overlapping portion of the coverage areas. The number of BSSs, APs, and STAs, and the coverage areas of the APs described in connection with the WLAN deployment of FIG. 1 are provided by way of illustration and not of limitation. Moreover, aspects of the various techniques described herein are at least partially based on the example WLAN deployment of FIG. 1 but need not be so limited.

The APs (e.g., AP1 105-a and AP2 105-b) shown in FIG. 1 are generally fixed terminals that provide backhaul services to STAs within its coverage area or region. In some applications, however, the AP may be a mobile or non-fixed terminal. The STAs (e.g., STA1 115-a, STA2 115-b, STA3 115-c, STA4 115-d, and STA5 115-e) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, a small cell, or any other suitable terminology. The various concepts described throughout this disclosure are intended to apply to all suitable wireless apparatus regardless of their specific nomenclature.

Each of STA1 115-a, STA2 115-b, STA3 115-c, STA4 115-d, and STA5 115-e may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications links 125. The APs can send frames to their respective STAs and receive frames from their respective STAs to communicate data and/or control information (e.g., signaling).

Each of AP1 105-a and AP2 105-b can establish a communications link 125 with an STA that is within the coverage area of the AP. Communications links 125 can comprise communications channels that can enable both uplink and downlink communications. When connecting to an AP, an STA can first authenticate itself with the AP and then associate itself with the AP. Once associated, a communications link 125 can be established between the AP and the STA such that the AP and the associated STA can exchange frames or messages through a direct communications channel.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for scheduling and grouping users or STAs for data transmission over an OFDMA frame may be applicable to any suitable wireless network regardless of the coverage range and the wireless access protocols utilized.

In an aspect, an AP, such as AP1 105-a may communicate with multiple STAs, such as STAs 115-a, 115-b, 115-d, and 115-e using MU-MIMO. In some examples, AP1 105-a may further group a subset of the STAs within proximity of AP1 105-a, such as STAs 115-a, 115-b, 115-d, and 115-e for uplink data transmission over an OFDMA frame. The subset of APs may be considered a multi-user group and the AP1 105-a may control the transmission power of the subset group based on a power imbalance between the STAs 115 and the AP 105. Further, by controlling the power of the STAs, the AP 105-a may have greater flexibility in determining how to group the STAs for uplink communications (e.g., which STAs transmit within the same OFDMA frame).

In accordance with various aspects of the present disclosure, an AP 105 may group a first subset of the STAs (e.g., 115-a and 115-b) while excluding a different second subset of STAs (e.g., 115-d, and 115-e) upon performing a full-band CQI for each of the STAs 115-a, 115-b, 115-d, and 115-e. The AP 105 may further consider amount of payload scheduled for uplink transmission from each of the plurality of STAs 115 in order to group one or more STAs. Thus, the AP 105-a may use an uplink multi-user power control scheme that handles power imbalance dynamically based on the received power, sensitivity, and power imbalance tolerance of the AP 105 in order to group a subset of the plurality of STAs (e.g., 115-a and 115-b) for service (e.g., selecting STAs that AP 105-a would allow to perform uplink OFDMA transmission during transmission opportunity) and a different subset of the plurality of STAs (e.g., 115-d, and 115-e) that may need to wait before transmitting.

Further aspects of the present disclosure provide techniques for the AP 105 to determine a data rate (e.g., modulation and coding schemes) for each STA 115 in a multi-user group. A closed loop power control scheme may be used to account for received signal strength indicator (RSSI) measurement and transmit power control errors such that the power imbalance tolerance of the AP 105 may be considered when selecting appropriate data rate(s) for the subset of the plurality of STAs based on the full-band CQI. In some examples, the AP 105 may measure a received signal strength from the plurality of STAs within the subset and set at least one of a modulation and coding scheme (MCS) rate and corresponding transmit power associated with the plurality of STAs 115. The AP 105 may also periodically apply power control and power imbalance verification in order to adjust the MCS rate, the transmit power or even the grouping of the service STAs in order to ensure that the cumulative received power at the AP 105 conforms to the power imbalance tolerance.

For example, if the AP 105-a groups a first subset of a plurality of STAs that are located in close proximity to the AP 105-a (or if they move closer to the AP 105-a), the cumulative received power magnitude may violate the power imbalance tolerance associated with the AP 105-a. Thus, the AP 105-a may need to either adjust the MCS rate, the transmit power or the grouping of the service STAs (e.g., my removing STAs 115 that are closer to the AP 105 in favor of those further away since STAs that are farther away would account for lower received power at the AP 105). Accordingly, in some examples, applying the power control and power imbalance verification may comprise instructing the plurality of STAs within the grouping subset to transmit at least one of an uplink data or an acknowledgment to the AP with an adjusted MCS rate or an adjusted transmit power in order to avoid power imbalance at the AP.

Accordingly, aspects of the present disclosure provide an efficient solution of controlling the power of the STAs in determining how to group the plurality STAs into subsets for uplink communications while considering the power imbalance tolerances of the AP 105 in identifying ideal data rate(s) for the plurality of STAs 115. Further techniques of the present disclosure, as will be illustrated in greater detail below, include allocating the sub-band resource unit(s) to the plurality of STAs 115 by identifying the sub-band resource unit(s) that correspond with a peak channel power for the plurality of STAs 115 based on the full-band CQI. By allocating the identified peak channel power sub-band resource unit(s) to the plurality of STAs 115, aspects of the present disclosure allow a STA 115 to transmit at a higher data rate than in conventional systems.

In yet further examples, the techniques of the present disclosure include monitoring (or “tracking” as used interchangeably) the channel power of the sub-band resource unit(s) during an uplink OFDMA transmission by the plurality of STAs and adjusting the data rate associated with the STA based on a channel power of the sub-band resource unit(s). By adjusting the data rates based on the channel power of the sub-band resource unit(s), the AP 105 may avoid continuously performing a full-band CQI for the plurality of STAs, and thus improves system efficiency.

In some examples, the CQI collected by the AP may include collecting a first partial band CQI from a first STA 115 and a second partial band CQI from a second STA 115. While the example is provided with two STAs 115, it should be appreciated that the full band may be subdivided to more than just two STAs 115. Thus, in some examples a first STA 115 may be allocated a first partial band (e.g., lower half of the full band), while a second STA 115 may be allocated a second partial band (e.g., upper half of the full band). Accordingly, features of the present disclosure provide techniques to schedule the first STA and the second STA with downlink OFDMA and use each of the first STA and second STA corresponding OFDMA acknowledgment (ACKs) to obtain CQI for the first partial band and second partial band respectively.

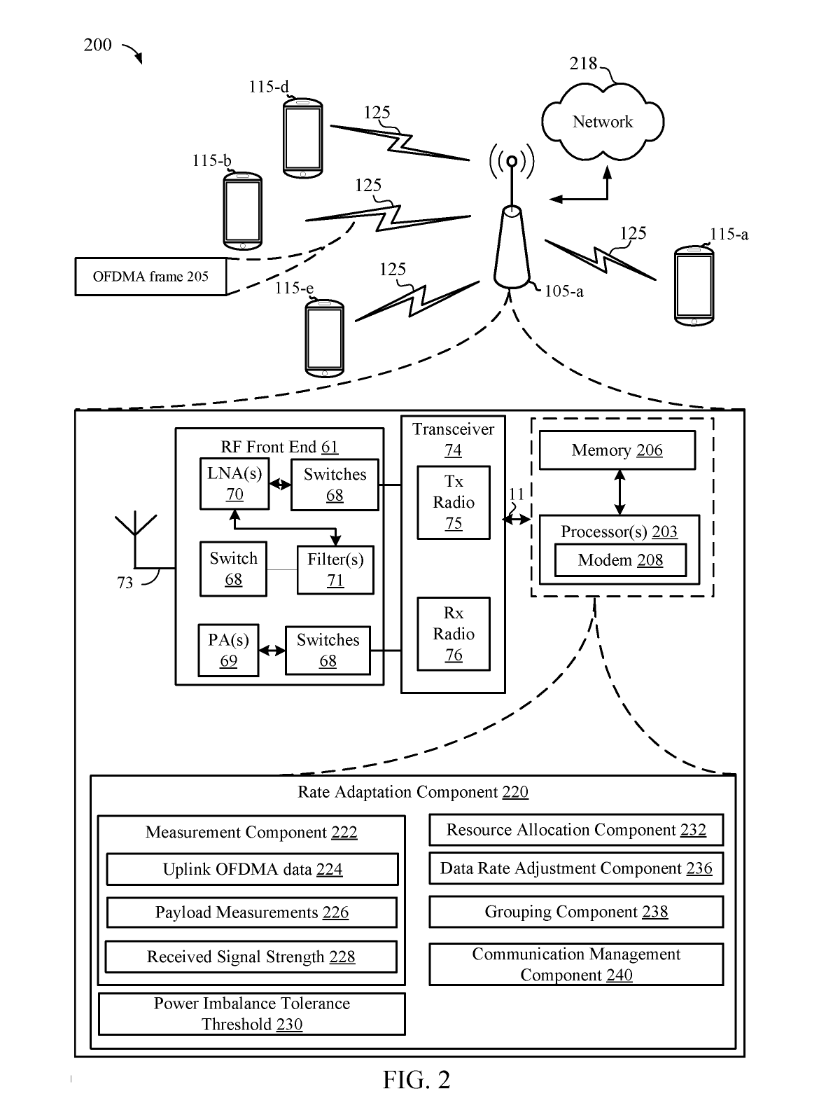

Referring to FIG. 2, in an aspect, a wireless communication system 200 includes STAs 115-a, 115-b, 115-d, and 115-e in wireless communication with at least one AP 105, such as AP1 105-a connected to network 218. The STAs 115 and AP 105 may be example of STAs 115 and AP 105 described above with reference to FIG. 1. The one or more STAs 115-a, 115-b, 115-d, and 115-e may communicate with network 218 via AP1 105-a. In an example, STAs 115-a, 115-b, 115-d, and 115-e may transmit and/or receive wireless communication to and/or from AP1 105-a via one or more communication links 125. For example, the communication links 125 may carry one or more OFDMA frames 205 in an uplink direction from, for example, the STA 115-b to the AP 105-a. Such wireless communications may include, but are not limited to, data, audio and/or video information. In some instances, such wireless communications may include control or similar information. In an aspect, an AP 105, such as AP1 105-a may be configured to control the transmission power of a multi-user group including a plurality of STAs 115, such as STAs 115-a, 115-b, 115-d, and 115-e, to maximize network capacity and throughput. Additionally or alternatively, the AP1 105-a may be configured to provide OFDMA rate adaptation based on channel power tracking as discussed herein. For example, AP1 105-a may perform power control and rate adaptation for one or more STAs 115-a, 115-b, 115-d, and 115-e via communications links 125.

In an aspect, the AP 105-a may include one or more processors 203 and/or memory 206 that may operate in combination with rate adaptation component 220 to perform the functions, methodologies (e.g., method 500 of FIG. 5), or methods presented in the present disclosure. In accordance with the present disclosure, the rate adaptation component 220 may include a measurement component 222 for measuring, at the AP 105-a, a full-band CQI for a plurality of STAs 115 associated with the AP1 105-a. As discussed above, the full-band may include a plurality of sub-band resource units. In some aspects, the full-band CQI may indicate the wireless channel's fading conditions between one or more STAs 115 and the AP1 105-a. By measuring the full-band CQI, each STA 115 may be allocated a sub-band resource units that allow for a highest MCS based on the current channel conditions. In some aspects, the measurement component 222 may perform the full-band CQI measurements (or “full-band CQI sounding”) based on two techniques described below.

In accordance with the first technique of performing full-band CQI measurements, the AP 105 may transmit a null payload packet(s) to the plurality of STA(s) 115. In some examples, the null payload packet may be a downlink single-user(SU)/multi-user(MU) packet of null payload. In response to the null payload packet transmitted by the AP1 105-a, the plurality of STAs 115 may transmit SU/MU-MIMO acknowledgements (ACKs) to the AP1 105-a. In some examples, the measurement component 222 may measure the full-band CQI for the plurality of STAs 105 associated with the AP 105 based on the SU/MU-MIMO acknowledgements.

In accordance with the second technique of performing full-band CQI measurements, the AP1 105-a may transmit a trigger (e.g., trigger for UL OFDMA transmission) to the plurality of STAs 115. In some aspects, the trigger may request the plurality of STAs 115 to measure downlink full-band CQI. Once the STAs 115 measure the downlink full-band CQI, the AP 105 may receive a plurality of user reports from the plurality of STAs 115 comprising the downlink full-band CQI via an uplink OFDMA transmission. Accordingly, measurement component 222 may calculate an uplink full-band CQI based on the downlink full-band CQI received from the plurality of wireless stations.

The rate adaptation component 220 may further include a grouping component 238 for grouping a subset of the plurality of STAs 115 based on the full band CQI. In some examples, at least one STA 115 may be a member of the subset. In addition to the full-band CQI, the grouping component 238, in grouping the subset of STAs, may further consider amount of payload scheduled for uplink transmission from the plurality of STAs 115. The AP1 105-a may obtain the payload measurements 226 by transmitting an uplink OFDMA buffer polling request to the plurality of STAs 115 to perform user buffer polling. In response, each STA 115 may determine its buffer status associated with uplink data scheduled for transmission and transmit an UL OFDMA buffer status to the AP 105.

In some aspects, the AP 105 may be configured to prioritize STAs 115 that have larger payload for transmission comparative to the STAs 115 with less data to transfer. As such, the grouping component 238 may group a subset of the plurality of the STAs 115 to include the STAs 115 with higher payload for service by the AP1 105-a while excluding from service STAs 115 with less data to transfer (e.g., configuring the excluded STAs 115 to wait for subsequent transmission opportunities and accumulate additional data to transmit together).

To that end, the rate adaptation component 220 may further include resource allocation component 232 for allocating a sub-band resource unit from the plurality of sub-band resource units to a wireless station of the plurality of STAs 115 based on the full-band CQI. Additionally, as the AP 105 may prioritize STAs 115 with larger payload for transmission comparative to STAs 115 with less data, the rate adaptation component 220 may allocate a wider sub-band resource unit to a higher priority STA 115 from the plurality of STAs 115 than sub-band resource units for lower priority STA 115. In further aspects of the present disclosure, the rate adaptation component 220, in allocating the sub-band resource unit from the plurality of sub-band resource units to the STA 115, may further identify the sub-band resource unit from the plurality of sub-band resource units that corresponds with a peak channel power for the STA 115 based on the full-band CQI and allocate the identified sub-band resource unit to the STA 115. As such, each STA 115 using the techniques of the present disclosure may transmit at a consistently higher data rates than comparative conventional systems. In some aspects, the size of the sub-band resource units and the locations within the resource blocks may vary based on different subset STAs 115 groupings.

The rate adaptation component 220 may further include a data rate adjustment component 236 for adjusting a data rate associated with the STA 115 based on a channel power of the sub-band resource unit. In some examples, adjusting the data rate associated with the STA 115 based on the channel power of the sub-band resource unit may comprise monitoring, by the AP1 105-a, the channel power of the sub-band resource unit during an uplink OFDMA transmissions by the STA 115 or the plurality of STAs 115. Particularly, the data rate adjustment component 236 may measure a received signal strength 228 from the STA 115 and set an initial MCS rate or a transmit power for the STA 115 based on the received signal strength 228. In some aspects, measuring the received signal strength 228 from the STA 115 may comprise transmitting, from the AP1 105-a, an uplink OFDMA trigger to the STA 115 in order to perform user buffer polling from the one or more STAs 115. In some examples, the AP1 105-a may further receive an uplink OFDMA data 224 from at least one STA 115 in response to the transmission of an uplink OFDMA trigger. In non-limiting examples, uplink OFDMA data 224 may include at least one of a transmission opportunity (TXOP) request, a buffer status report, an UL OFDMA data packet, or UL OFDMA acknowledgements. Thus, in some examples, measuring the received signal strength 228 may be based on an uplink OFDMA data that includes either TXOP request or a buffer status report.

Once the initial MCS rate and/or transmit power for the STAs 115 is selected by the AP1 105-a based on the measured signal strength 228, the data rate adjustment component 236 may monitor the sub-band resource units associated with the STAs 115 and periodically apply a power control and power imbalance verification to adjust the data rate. Applying the power control and power imbalance verification may comprise instructing the STA 115 to transmit at least one of an uplink data or an acknowledgment to the AP1 105-a with an adjusted MCS rate or an adjusted transmit power to avoid power imbalance at the AP1 105-a. Accordingly, the data rate adjustment component 236 may ensure that the received power at the AP1 105-a is within the power imbalance tolerance threshold 230. Additional details regarding power imbalance tolerance are described in Provisional Application Ser. No. 62/304,798 and incorporated by reference herein.

In some aspects, adjusting the data rate associated with the wireless station 115 based on the channel power of the sub-band resource unit by data rate adjustment component 236 may comprise transmitting, from the AP 105, an uplink OFDMA buffer polling request to the wireless station to perform user buffer polling and receiving, from the wireless station 115, an UL OFDMA buffer status in response to the OFDMA buffer polling request. Accordingly, the data rate adjustment component 236 may determine the channel power of the sub-band resource unit associated with the wireless station based on the UL OFDMA buffer status.

In yet further examples, adjusting the data rate associated with the wireless station 115 based on the channel power of the sub-band resource unit by data rate adjustment component 236 may comprise transmitting, from the AP 105, a downlink OFDMA null data packet to the wireless station and receiving, from the wireless station, an UL OFDMA acknowledgement in response to the OFDMA null data packet. In some aspects, the data rate adjustment component 236 may determine the channel power of the sub-band resource unit associated with the wireless station based on the UL OFDMA acknowledgement.

Additionally or alternatively, adjusting the data rate associated with the wireless station 115 based on the channel power of the sub-band resource unit by data rate adjustment component 236 may comprise determining that the channel power of the sub-band resource unit has changed in excess of a threshold and verifying the full-band CQI based on PER of a consecutive packets received at the AP after determining that the channel power of the sub-band resource unit has changed in excess of the threshold. In such instance, data rate adjustment component 236 may adjust the data rate associated with the wireless station 115 by verifying the channel variations against PER of consecutive packets. In some aspects, the data rate may include at least one of a MCS rate or a number of spatial streams (NSS).

The rate adaptation component 220 may further include communication management component 240 for communicating, from the AP 105, the data rate to the wireless station 115 via the transceiver 74. In some aspects, the wireless station(s) 115 may utilize the data rate(s) to communicate with the AP 105.

The one or more processors 203 may include a modem 208 that uses one or more modem processors. The various functions related to the rate adaptation component 220 may be included in modem 208 and/or processor 203 and, in an aspect, can be executed by a single processor, while in other aspects, different ones of the functions may be executed by a combination of two or more different processors. For example, in an aspect, the one or more processors 203 may include any one or any combination of a modem processor, or a baseband processor, or a digital signal processor, or a transmit processor, or a transceiver processor associated with transceiver 74, or a system-on-chip (SoC). In particular, the one or more processors 203 may execute functions and components included in the rate adaptation component 220.

In some examples, the rate adaptation component 220 and each of the sub-components may comprise hardware, firmware, and/or software and may be configured to execute code or perform instructions stored in a memory (e.g., a computer-readable storage medium, such as memory 206 discussed below). Moreover, in an aspect, AP 105 may include RF front end 61 and transceiver 74 for receiving and transmitting radio transmissions, for example, wireless communications transmitted by STAs 115. For example, transceiver 74 may receive a packet transmitted by the STAs 115. The AP 105, upon receipt of an entire message, may decode the message and perform a cyclic redundancy check (CRC) to determine whether the packet was received correctly. For example, transceiver 74 may communicate with modem 208 to forward the received messages to the rate adaptation component 220 for analyzing (e.g., channel power measurements or signal strength measurements). In other examples, the transceiver 74 may coordinate with the modem 208 to transmit messages generated by the rate adaptation component 220 (e.g., updated MCS rates or transmit powers for STAs) to the STAs. RF front end 61 may be connected to one or more antennas 73 and can include one or more switches 68, one or more amplifiers (e.g., power amplifiers (PAs) 69 and/or low-noise amplifiers 70), and one or more filters 71 for transmitting and receiving RF signals on the uplink channels and downlink channels. In an aspect, components of RF front end 61 can connect with transceiver 74. Transceiver 74 may connect to one or more modems 108 and processor 20.

Transceiver 74 may be configured to transmit (e.g., via transmitter radio 75) and receive (e.g., via receiver radio 76) and wireless signals through antennas 73 via RF front end 61. In an aspect, transceiver may be tuned to operate at specified frequencies such that AP 105 can communicate with, for example, STAs 115. In an aspect, for example, modem 208 can configure the transceiver 74 to operate at a specified frequency and power level based on the AP configuration of the AP 105 and communication protocol used by modem.

The AP 105 may further include a memory 206, such as for storing data used herein and/or local versions of applications or rate adaptation component 220 and/or one or more of its subcomponents being executed by processor 203. Memory 206 can include any type of computer-readable medium usable by a computer or processor 203, such as random access memory (RAM), read only memory (ROM), tapes, magnetic discs, optical discs, volatile memory, non-volatile memory, and any combination thereof. In an aspect, for example, memory 206 may be a computer-readable storage medium that stores one or more computer-executable codes defining rate adaptation component 220 and/or one or more of its subcomponents. Additionally or alternatively, the AP 105 may include a bus 11 for coupling the RF front end 61, transceiver 74, memory 206 and processor 203 and to exchange signaling information between each of the components and/or subcomponents of the AP 105.

FIGS. 3A and 3B are diagrams illustrating sub-band resource allocations based on identification of the peak channel power for the wireless stations in a wireless network. FIG. 3A illustrates a full-band 305 that may include a plurality of sub-band resource units 310, 315, and 320. Although each sub-band resource units 310, 315, and 320 is illustrated as having equal size (e.g., in terms of width), each sub-band resource unit may be of varying size and width. A “wider” resource unit may correspond with a higher bandwidth for the allocated wireless station comparative to a “narrower” resource unit that may correspond with a lower bandwidth. In accordance with various techniques of the present disclosure, each wireless station 115 may be allocated to the sub-band resource unit that corresponds with its peak resource unit based on the full band channel power. It should be noted that the full-band channel power peak of the UL OFDMA and that of downlink OFDMA of the same STA 115 may be located in the same sub-band resource unit due to channel reciprocity.

FIG. 3B illustrates a graph of full-band channel power for each wireless STA 115-a, 115-b and 115-c. As illustrated, for each wireless STA 115, the peak channel power varies considerably. For example, for first wireless station 115-a, the peak channel power corresponds in the middle of the full-band, while for the second wireless station 115-b, the peak channel power is at the tail end of the full-band. Comparatively, the peak channel power for the third wireless station 115-c may be at the beginning portion of the full-band. Accordingly, while allocating the sub-band resource units 310, 315, and 320 to the plurality of wireless stations in the selected subset grouping, the AP 105 may identify the sub-band resource unit from the plurality of sub-band resource units that corresponds with a peak channel power for the wireless station 115 based on the full-band CQI and allocate the identified sub-band resource unit to the wireless station 115. Thus, in the illustrated example, the first wireless station 115-a may be allocated the first sub-band resource unit 315, the second wireless station 115-b may be allocated the second sub-band resource unit 320, and the third wireless station 115-c may be allocated the third sub-band resource unit 310.

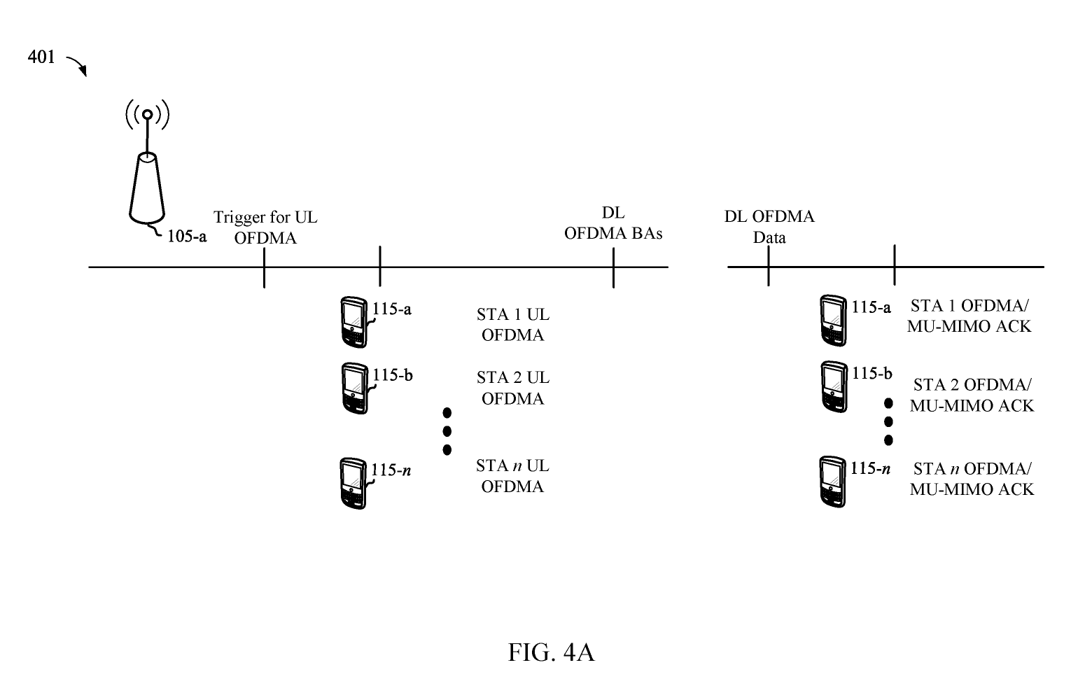

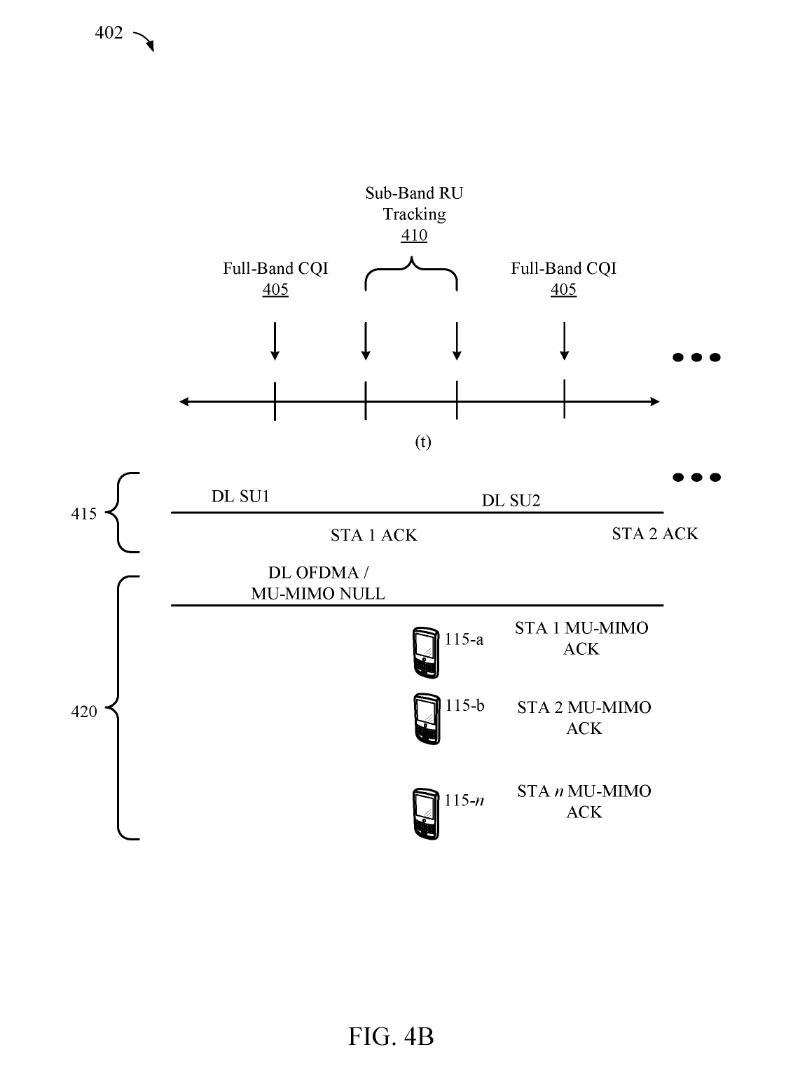

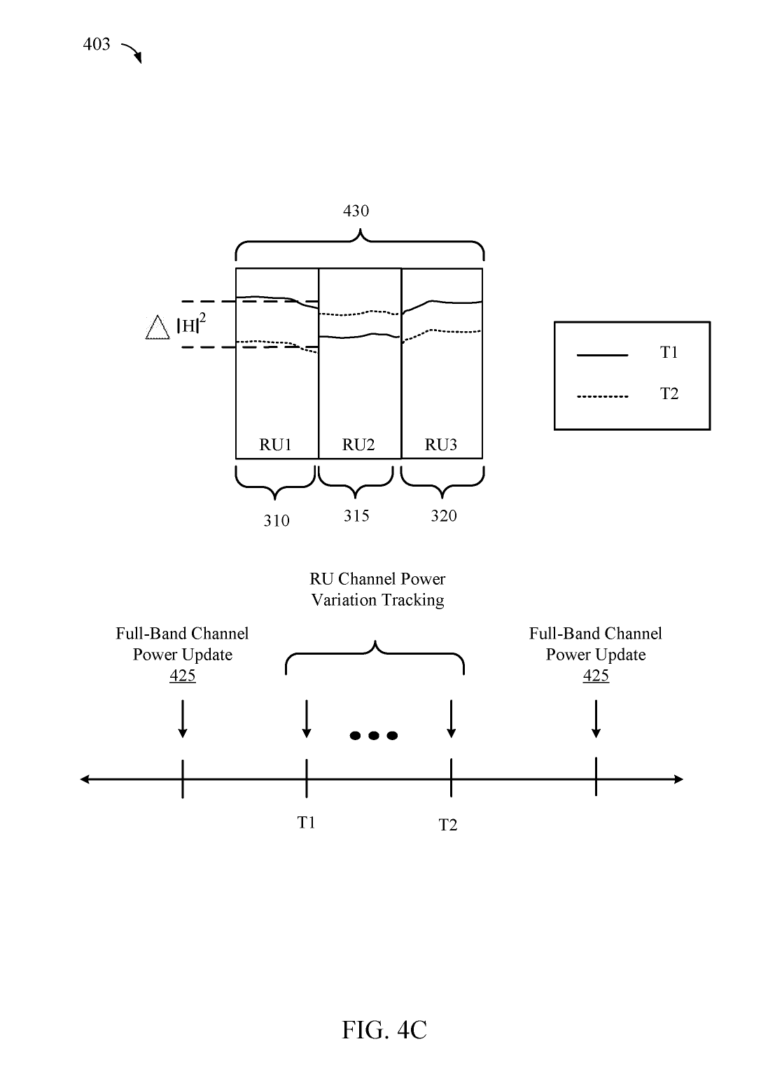

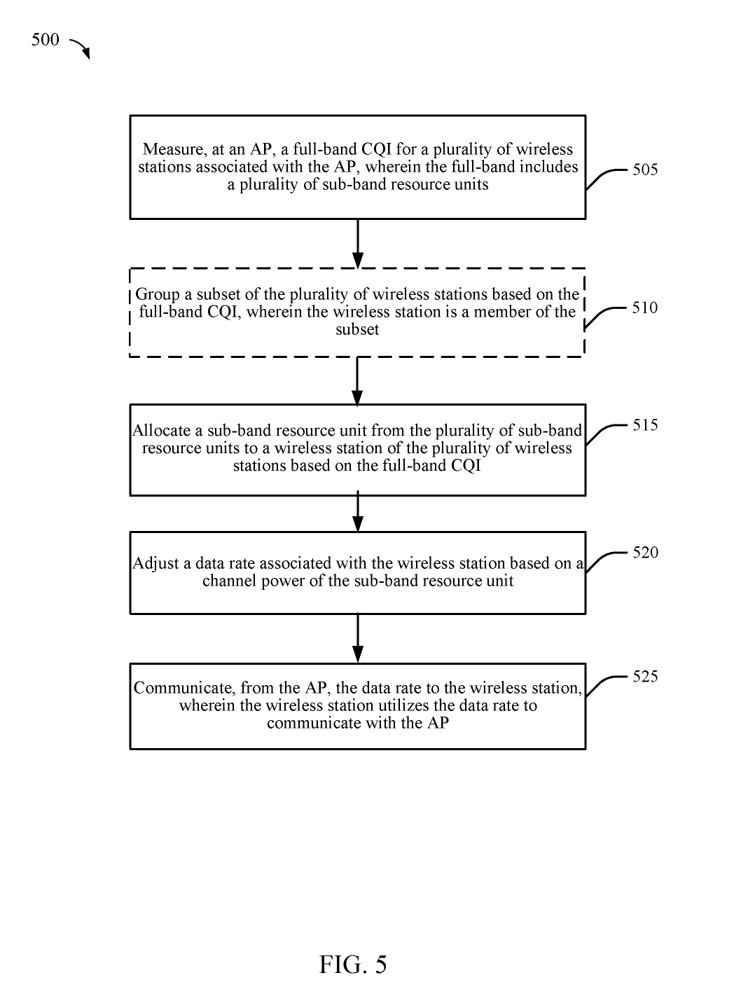

FIGS. 4A-4C are diagrams that illustrate communication between AP 105 and one or more wireless stations 115 for rate adaptation based on channel power tracking in accordance with various aspects of the present disclosure. As noted above, aspects of the present disclosure provide techniques for OFDMA rate adaptation based on channel power tracking that offers advantages over conventional systems because monitoring sub-band resource units as oppose to drawing inferences from PER of consecutive packets of channel conditions provides faster rate calculations that are more accurate and reliable. In order for wireless stations 115 to perform uplink transmissions to the AP 105 over wireless channels, the wireless stations 115 must first contend for UL OFDMA transmission resources and conform to the power control constraints dictated by the AP 105. In some aspects, the AP 105 may provide power control information such as maximum and minimum transmission power and MCS/Transmission power lookup table to the plurality of wireless stations 115 during attachment procedures.

In accordance with various aspects of the present disclosure, the AP 105 may measure received signal strength of the plurality of wireless stations and set initial MCS rate and transmission power for the wireless stations to adopt. The AP 105 may also perform buffer polling of wireless stations 115 to identify an amount of payload that each wireless station 115 may have pending for uplink transmission.

Additionally or alternatively, the AP 105 may measure a full-band CQI for the plurality of the wireless stations 115 associated with the AP 105. As discussed above, the AP 105 may perform initial grouping (e.g., selecting a subset of the plurality of wireless stations) based on the full-band CQI and the buffer polling information obtained from the plurality of wireless stations 115. Periodically, the AP 105 may apply power control and power imbalance verification to the wireless stations 115 in order to update the MCS rates and transmission power values associated with the wireless stations based on power imbalance intolerance threshold of the AP 105. Thus, the AP 105 may instruct wireless stations to transmit its uplink data or acknowledgements to the AP 105 with specified MCS rate and transmission power value to avoid power imbalance related performance loss at the AP 105.

As illustrated in diagram 401 of FIG. 4A, AP 105, in order to adjust the MCS rates and the transmission power values for the various wireless stations in the grouped subset of wireless stations, may need to measure the signal strength of each wireless station. In some aspects, the AP 105 may measure the received signal strength from the plurality of wireless stations by transmitting, from the AP 105-a, an uplink OFDMA trigger signal to the wireless stations 115. In some aspects, a beacon transmitted by the AP 105 may signal to the wireless stations 115 when the next trigger frame will be broadcasted by the AP 105. As such, in response to the OFDMA polling trigger, the plurality of wireless stations 115 may transmit UL OFDMA data that includes TXOP request or a buffer status report associated with the plurality of wireless stations 115. In some examples, the AP 105 may measure the received signal strength based on the uplink OFDMA data received from the plurality of wireless stations 115. In some examples, the received signal strength may be measured in frequency domain by the AP 105 where the AP 105 may measure multiple STAs' 115 RSSI of UL OFDMA data in the frequency domain concurrently. Particularly, with the known transmission power value (set by the AP 105 initially) and the measured received signal strength, the AP 105 may be configured to accurately calculate the path loss on the channel between the AP 105 and the STA 115. Accordingly, once the station RSSI information associated with the plurality of wireless stations 115 is available, the AP 105 may provide an updated MCS and transmission power values to the wireless station in order to improve throughput.

FIG. 4B illustrates a diagram 402 for proposed techniques of reducing delay in acquiring power variation tracking associated with multiple stations 115 in accordance with various aspects of the present disclosure. As noted above, in order for the AP 105 to measure the full-band CQI for the plurality of wireless stations and modify the data rates based on sub-band resource unit tracking, the AP 105 generally requests wireless stations to transmit UL OFDMA data or acknowledgements to the AP 105. In some examples, the AP 105 may initiate such transfer by transmitting a null payload packet to the plurality of wireless stations. However, as illustrated in FIG. 4B, timing segment 410 illustrates one aspect where the AP 105 first sends a DL SU/MU packet of null payload to the each STA 115 to which each STA 115 serially sends full-band SU-MU-MIMO ACK to the AP 105 for the full-band channel measurement. However, with each STA 115 transmitting its acknowledgements separately at different times, the AP 105 may experience significant delay in obtaining full-band CQI. In order to expedite the processing, aspects of the present disclosure provide for transmitting a MU-MIMO packet of null payload to the plurality of the wireless stations 115 as shown in timing segment 420 to which all the corresponding wireless stations 115-a (through 115-n) respond with MU-MIMO Acknowledgment message to the AP 105. Accordingly, the AP 105 may measure the full-band CQI for the plurality of wireless stations associated with the AP based on the MU-MIMO acknowledgements in shorter time period than the original method illustrated in timing segment 415.

FIG. 4C illustrates a diagram 403 of aspects of achieving efficiency in channel power tracking for rate adaptation in accordance with various aspects of the present disclosure. Particularly, as discussed above, some systems that relied upon PER for rate adaptations suffered from efficiencies due to substantial overhead required in its implementation. In one example, PER based rate adaptation schemes periodically (e.g., every 50 ms) sent probe frames that identified a new data rate that incremented (or decremented) the previous rate by predetermined value (e.g., usually value of 1). Therefore, any changes in the data rates were slow and incremental. However, transmitting probe frames requires air time over wireless channels, and thus blindly and periodically sending probe frames may be counter intuitive.

Aspects of the present disclosure provide techniques of detecting variations in sub-band resource unit CQI to inform the AP 105 when to transmit a probe frame. Particularly, based on the magnitude of the sub-band resource unit CQI, the AP 105 may be configured to adjust rate adaptation steps more accurately and by greater margins than by increments of only one. Diagram 403 illustrates this principle in detail.

In some aspects, at 425, the AP 105 measuring the full-band CQI for the plurality of wireless stations associated with the AP and allocates a sub-band resource units from the plurality of sub-band resource units to the plurality of wireless stations 115. Thereafter, at 430, the AP 105 monitors the sub-band resource unit CQIs of resource unit (RU) 1, RU2, and RU3 to determine the uplink resource channel power variation. In some aspects, the AP 105 may calculate the uplink RU channel power variation based on the following expression:

ΔP^{RU}=Δ∥H|²−ΔP^{UL}^{_}^{A} (1)

In some aspects, the UL ACK Channel power variation may include analog gain change (ΔP^{UL}^{_}^{A}) in the UL path that would need to be removed from consideration. In some aspects, ΔP^{UL}^{_}^{A} may consist of station transmit power and the receiver gain. Once the uplink RU channel power variation ΔP^{RU} has been calculated, the ΔP^{RU} may be mapped to MCS update to identify a target resource unit for the STA.

Referring to FIG. 5, an example of one or more operations of an aspect of rate adaptation according to the present apparatus and methods are described with reference to one or more methods and one or more components that may control data rates and power for a wireless station in a multi-user group during wireless communications. Although the operations described below are presented in a particular order and/or as being performed by an example component, it should be understood that the ordering of the actions and the components performing the actions may be varied, depending on the implementation. Moreover, it should be understood that the following actions or components described with respect to the rate adaptation component 220 and/or its subcomponents may be performed by a specially-programmed processor, a processor executing specially-programmed software or computer-readable media, or by any other combination of a hardware component and/or a software component specially configured for performing the described actions or components. Additionally, although the method 500 is described as being performed for a single wireless station within a multi-user group, it should be appreciated that the method 500 may be performed for additional wireless stations within the multi-user group.

At block 505, method 500 includes measuring, at an AP, a full-band CQI for a plurality of wireless stations associated with the AP, wherein the full-band includes a plurality of sub-band resource units. Aspects of block 505 may be performed by measurement component 222 as described with reference to FIG. 2.

At block 510, method 500 may optionally include grouping a subset of the plurality of wireless stations based on the full-band CQI, wherein the wireless station is a member of the subset. Aspects of block 510 may be performed by grouping component 238 as described with reference to FIG. 2.

At block 515, method 500 may include allocating a sub-band resource unit from the plurality of sub-band resource units to a wireless station of the plurality of wireless stations based on the full-band CQI. Aspects of block 515 may be performed by resource allocation component 232 as described with reference to FIG. 2.

At block 520, method 500 may include adjusting a data rate associated with the wireless station based on a channel power of the sub-band resource unit. Aspects of block 520 may be performed by data rate adjustment component 236 as described with reference to FIG. 2.

At block 525, method 500 may include communicating, from the AP, the data rate to the wireless station to allow the wireless station to utilize the data rate to communicate with the AP. Aspects of block 525 may be performed by communication management component 240 in collaboration with transceiver 74 as described with reference to FIG. 2.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Aspects of the disclosure are provided in the above description and related drawings directed to specific disclosed aspects. Alternate aspects may be devised without departing from the scope of the disclosure. Additionally, well-known aspects of the disclosure may not be described in detail or may be omitted so as not to obscure more relevant details. Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the disclosure can include a computer readable medium embodying a method for dynamic bandwidth management for transmissions in unlicensed spectrum. Accordingly, the disclosure is not limited to the illustrated examples.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method for rate adaptation in wireless communications, comprising:
measuring, at an access point (AP), full-band channel quality information (CQI) for a plurality of wireless stations associated with the AP, wherein the full-band includes a plurality of sub-band resource units;
allocating a sub-band resource unit from the plurality of sub-band resource units to a wireless station of the plurality of wireless stations based on the full-band CQI;
adjusting a data rate associated with the wireless station based on a channel power of the sub-band resource unit; and
communicating, from the AP, the data rate to the wireless station to allow the wireless station to utilize the data rate to communicate with the AP.

2. The method of claim 1, further comprising:
grouping a subset of the plurality of wireless stations based on the full-band CQI, wherein the wireless station is a member of the subset.

3. The method of claim 1, wherein allocating the sub-band resource unit from the plurality of sub-band resource units to the wireless station comprises:
identifying the sub-band resource unit from the plurality of sub-band resource units that corresponds with a peak channel power for the wireless station based on the full-band CQI; and
allocating the identified sub-band resource unit to the wireless station.

4. The method of claim 1, wherein adjusting the data rate associated with the wireless station based on the channel power of the sub-band resource unit, comprises:
monitoring, by the AP, the channel power of the sub-band resource unit during an uplink Orthogonal Frequency-Division Multiple Access (OFDMA) transmissions by the wireless station.

5. The method of claim 1, wherein adjusting the data rate associated with the wireless station based on the channel power of the sub-band resource unit, comprises:
measuring a received signal strength from the wireless station; and
setting at least one of a Modulation and Coding Scheme (MCS) rate or a transmit power for the wireless station based on the received signal strength.

6. The method of claim 5, further comprising:
applying a power control and power imbalance verification to adjust the data rate, wherein applying the power control and power imbalance verification comprises instructing the wireless station to transmit at least one of:
an uplink data; or
an acknowledgment to the AP with an adjusted MCS rate or an adjusted transmit power to avoid power imbalance at the AP.

7. The method of claim 5, wherein measuring the received signal strength from the wireless station comprises:
transmitting, from the AP, an uplink Orthogonal Frequency-Division Multiple Access (OFDMA) trigger to the wireless station to perform user buffer polling;
receiving, at the AP, an uplink OFDMA data from the wireless station in response to the uplink OFDMA trigger, wherein the uplink OFDMA data includes at least one of a transmission opportunity (TXOP) request or a buffer status report; and
measuring the received signal strength based on the uplink OFDMA data.

8. The method of claim 1, wherein allocating the sub-band resource unit from the plurality of sub-band resource units to the wireless station comprises:
receiving, from the plurality of wireless stations, at least one of a transmission opportunity (TXOP) request or a buffer status report;
identifying an amount of payload scheduled for uplink transmission from each of the plurality of wireless stations based on the TXOP request or the buffer status report;
prioritizing the plurality of wireless stations based on the amount of payload scheduled for uplink transmission; and
allocating a wider sub-band resource unit to a higher priority wireless station from the plurality of wireless stations than sub-band resource units for lower priority wireless station.

9. The method of claim 1, wherein measuring the full-band CQI for the plurality of wireless stations associated with the AP comprises:
transmitting, from the AP, a null payload packet to the plurality of wireless stations;
receiving, from the plurality of wireless stations, multi-user multiple-input-multiple-output (MU-MIMO) acknowledgements in response to the null payload packet transmitted by the AP; and
measuring the full-band CQI for the plurality of wireless stations associated with the AP based on the MU-MIMO acknowledgements.

10. The method of claim 1, wherein measuring the full-band CQI for the plurality of wireless stations associated with the AP comprises:
transmitting, from the AP, a trigger to the plurality of wireless stations, wherein the trigger requests the plurality of wireless stations to measure downlink full-band CQI;
receiving user reports from the plurality of wireless stations comprising the downlink full-band CQI via uplink Orthogonal Frequency-Division Multiple Access (OFDMA); and
calculating an uplink full-band CQI based on the downlink full-band CQI received from the plurality of wireless stations.

11. The method of claim 1, wherein adjusting the data rate associated with the wireless station based on the channel power of the sub-band resource unit comprises:
determining that the channel power of the sub-band resource unit has changed in excess of a threshold;
verifying the full-band CQI based on packet error rate (PER) of a consecutive packets received at the AP after determining that the channel power of the sub-band resource unit has changed in excess of the threshold; and
adjusting the data rate associated with the wireless station based on the verifying, wherein the data rate includes at least one of a Modulation and Coding Scheme (MCS) rate or a number of spatial streams (NSS).

12. The method of claim 1, wherein adjusting the data rate associated with the wireless station based on the channel power of the sub-band resource unit comprises:
transmitting, from the AP, an uplink Orthogonal Frequency-Division Multiple Access (OFDMA) buffer polling request to the wireless station to perform user buffer polling;
receiving, from the wireless station, an UL OFDMA buffer status in response to the OFDMA buffer polling request; and
determining the channel power of the sub-band resource unit associated with the wireless station based on the UL OFDMA buffer status.

13. The method of claim 1, wherein adjusting the data rate associated with the wireless station based on the channel power of the sub-band resource unit comprises:
transmitting, from the AP, a downlink Orthogonal Frequency-Division Multiple Access (OFDMA) null data packet to the wireless station;
receiving, from the wireless station, an UL OFDMA acknowledgement in response to the OFDMA null data packet; and
determining the channel power of the sub-band resource unit associated with the wireless station based on the UL OFDMA acknowledgement.

14. The method of claim 1, wherein measuring the full-band CQI for the plurality of wireless stations associated with the AP comprises:
receiving a first partial band CQI from a first STA;
receiving a second partial band CQI from a second STA; and
measuring the full-band CQI based on the first partial band CQI and the second partial band CQI.

15. An access point (AP) for wireless communications, comprising:
a transceiver;
a memory configured to store instructions;
a processor communicatively coupled to the transceiver and the memory, the processor configured to execute the instructions to:
measure, at the AP, full-band channel quality information (CQI) for a plurality of wireless stations associated with the AP, wherein the full-band includes a plurality of sub-band resource units;
allocate a sub-band resource unit from the plurality of sub-band resource units to a wireless station of the plurality of wireless stations based on the full-band CQI;
adjust data rate associated with the wireless station based on a channel power of the sub-band resource unit; and
communicate, from the AP via the transceiver, the data rate to the wireless station to allow the wireless station to utilize the data rate to communicate with the AP.

16. The AP of claim 15, wherein the processor is further configured to:
group a subset of the plurality of wireless stations based on the full-band CQI, wherein the wireless station is a member of the subset.

17. The AP of claim 15, wherein the processor configured to allocate the sub-band resource unit from the plurality of sub-band resource units to the wireless station is further configured to:
identify the sub-band resource unit from the plurality of sub-band resource units that corresponds with a peak channel power for the wireless station based on the full-band CQI; and
allocate the identified sub-band resource unit to the wireless station.

18. The AP of claim 15, wherein the processor configured to adjust the data rate associated with the wireless station based on the channel power of the sub-band resource unit, is further configured to:
monitor the channel power of the sub-band resource unit during an uplink Orthogonal Frequency-Division Multiple Access (OFDMA) transmissions by the wireless station.

19. The AP of claim 15, wherein the processor configured to adjust the data rate associated with the wireless station based on the channel power of the sub-band resource unit, is further configured to:
measure a received signal strength from the wireless station; and
set at least one of a Modulation and Coding Scheme (MCS) rate or a transmit power for the wireless station based on the received signal strength.

20. The AP of claim 19, wherein the processor is further configured to:
apply a power control and power imbalance verification to adjust the data rate, wherein applying the power control and power imbalance verification comprises instructing the wireless station to transmit at least one of:
an uplink data; or
an acknowledgment to the AP with an adjusted MCS rate or an adjusted transmit power to avoid power imbalance at the AP.

21. The AP of claim 19, wherein the processor configured to measure the received signal strength from the wireless station is further configured to:
transmit, from the AP, an uplink Orthogonal Frequency-Division Multiple Access (OFDMA) trigger to the wireless station to perform user buffer polling;
receive, at the AP, an uplink OFDMA data from the wireless station in response to the uplink OFDMA trigger, wherein the uplink OFDMA data includes at least one of a transmission opportunity (TXOP) request or a buffer status report; and
measure the received signal strength based on the uplink OFDMA data.

22. The AP of claim 15, wherein the processor configured to allocate the sub-band resource unit from the plurality of sub-band resource units to the wireless station is further configured to:
receive, from the plurality of wireless stations, at least one of a transmission opportunity (TXOP) request or a buffer status report;
identify an amount of payload scheduled for uplink transmission from each of the plurality of wireless stations based on the TXOP request or the buffer status report;
prioritize the plurality of wireless stations based on the amount of payload scheduled for uplink transmission; and
allocate a wider sub-band resource unit to a higher priority wireless station from the plurality of wireless stations than sub-band resource units for lower priority wireless station.

23. The AP of claim 15, wherein the processor configured to measure the full-band CQI for the plurality of wireless stations associated with the AP is further configured to:
transmit, from the AP, a null payload packet to the plurality of wireless stations;
receive, from the plurality of wireless stations, multi-user multiple-input-multiple-output (MU-MIMO) acknowledgements in response to the null payload packet transmitted by the AP; and
measure the full-band CQI for the plurality of wireless stations associated with the AP based on the MU-MIMO acknowledgements.

24. The AP of claim 15, wherein the processor configured to measure the full-band CQI for the plurality of wireless stations associated with the AP is further configured to:
transmit, from the AP, a trigger to the plurality of wireless stations, wherein the trigger requests the plurality of wireless stations to measure downlink full-band CQI;
receive user reports from the plurality of wireless stations comprising the downlink full-band CQI via uplink Orthogonal Frequency-Division Multiple Access (OFDMA); and
calculate an uplink full-band CQI based on the downlink full-band CQI received from the plurality of wireless stations.

25. The AP of claim 15, wherein the processor configured to adjust the data rate associated with the wireless station based on the channel power of the sub-band resource unit is further configured to:
determine that the channel power of the sub-band resource unit has changed in excess of a threshold;
verify the full-band CQI based on packet error rate (PER) of a consecutive packets received at the AP after determining that the channel power of the sub-band resource unit has changed in excess of the threshold; and
adjust the data rate associated with the wireless station based on the verifying, wherein the data rate includes at least one of a Modulation and Coding Scheme (MCS) rate or a number of spatial streams (NSS).

26. The AP of claim 15, wherein the processor configured to adjust the data rate associated with the wireless station based on the channel power of the sub-band resource unit is further configured to:
transmit, from the AP, an uplink Orthogonal Frequency-Division Multiple Access (OFDMA) buffer polling request to the wireless station to perform user buffer polling;
receive, from the wireless station, an UL OFDMA buffer status in response to the OFDMA buffer polling request; and
determine the channel power of the sub-band resource unit associated with the wireless station based on the UL OFDMA buffer status.

27. The AP of claim 15, wherein the processor configured to adjust the data rate associated with the wireless station based on the channel power of the sub-band resource unit is further configured to:
transmit, from the AP, a downlink Orthogonal Frequency-Division Multiple Access (OFDMA) null data packet to the wireless station;
receive, from the wireless station, an UL OFDMA acknowledgement in response to the OFDMA null data packet; and
determine the channel power of the sub-band resource unit associated with the wireless station based on the UL OFDMA acknowledgement.

28. The AP of claim 15, wherein the processor configured to measure the full-band CQI for the plurality of wireless stations associated with the AP is further configured to:
receive a first partial band CQI from a first STA;
receive a second partial band CQI from a second STA; and
measure the full-band CQI based on the first partial band CQI and the second partial band CQI.

29. An access point (AP) for rate adaptation in wireless communications, comprising:
means for measuring, at the AP, full-band channel quality information (CQI) for a plurality of wireless stations associated with the AP, wherein the full-band includes a plurality of sub-band resource units;
means for allocating a sub-band resource unit from the plurality of sub-band resource units to a wireless station of the plurality of wireless stations based on the full-band CQI;
means for adjusting a data rate associated with the wireless station based on a channel power of the sub-band resource unit; and
means for communicating, from the AP, the data rate to the wireless station to allow the wireless station to utilize the data rate to communicate with the AP.

30. A computer-readable medium storing computer executable code for rate adaptation in wireless communications, comprising code to:
measure, at an access point (AP), full-band channel quality information (CQI) for a plurality of wireless stations associated with the AP, wherein the full-band includes a plurality of sub-band resource units;
allocate a sub-band resource unit from the plurality of sub-band resource units to a wireless station of the plurality of wireless stations based on the full-band CQI;
adjust a data rate associated with the wireless station based on a channel power of the sub-band resource unit; and
communicate, from the AP, the data rate to the wireless station to allow the wireless station to utilize the data rate to communicate with the AP.
